(19) United States
(12) Patent Application Publication
(10) Pub. No.: US 2025/0005808 A1
(43) Pub. Date: Jan. 2, 2025

(54) IMAGE STYLE MIGRATION METHOD AND APPARATUS, IMAGE STYLE MIGRATION MODEL TRAINING METHOD AND APPARATUS, AND DEVICE AND MEDIUM

(71) Applicant: Beijing Bytedance Network Technology Co., Ltd., Beijing (CN)

(72) Inventors: Chunji YIN, Beijing (CN); Guohong WU, Beijing (CN); Caijin ZHOU, Beijing (CN); Wenyue LI, Beijing (CN); Yunhao LI, Beijing (CN); Yujun SHEN, Beijing (CN)

(21) Appl. No.: 18/697,957

(22) PCT Filed: Sep. 21, 2022
(86) PCT No.: PCT/CN2022/120163

§ 371 Date: Apr. 2, 2024

(30) Foreign Application Priority Data
Oct. 11, 2021 (CN) 202111183748.6

(51) Int. Cl. G06T 11/00; G06V 10/77; G06V 10/774; G06V 10/776; G06V 10/82

(52) U.S. Cl. CPC G06T 11/00; G06V 10/7715; G06V 10/774; G06V 10/776; G06V 10/82

(57) ABSTRACT

The present disclosure relates to an image style transfer method and apparatus, an image style transfer model training method and apparatus, a device, and a medium. The image style transfer model training method includes: acquiring a first number of portrait image samples, training a preset neural network model by using the portrait image samples to determine a portrait image generation model and portrait model parameters; acquiring a second number of style image samples, training the portrait image generation model by using the style image samples to determine style model parameters, the second number being less than the first number; determining transfer model parameters based on the portrait model parameters and the style model parameters; and generating a first image style transfer model based on the transfer model parameters and the preset neural network model.

### CROSS-REFERENCE TO RELATED APPLICATIONS

This is a national stage application based on International Patent Application No. PCT/CN2022/120163, filed Sep. 21, 2022, which claims priority to Chinese Patent Application No. 202111183748.6, filed on Oct. 11, 2021 and titled “image style transfer method and apparatus, image style transfer model training method and apparatus, device, and medium”, the disclosures of which are incorporated herein by reference in their entireties.

### TECHNICAL FIELD

The present disclosure relates to the field of image processing technology, and in particular to an image style transfer method and apparatus, an image style transfer model training method and apparatus, a device, and a medium.

### BACKGROUND

Image style transfer refers to transferring a style (main attributes of a main target in an image, such as the facial expression and orientation, hair style, lighting, skin color, and other features) of a first image to a second image, and a presentation effect of a final image obtained is a perfect combination of an image content of the second image and an image style of the first image. The image style transfer has been widely used in photography, animation, games, e-commerce, and many other fields.

Currently, one of the main ways to implement the image style transfer is to train an image style transfer model, and then use the trained image style transfer model to generate an image with style transfer. However, the existing training of the image style transfer model relies heavily on training data, and a large number of stylized images (images containing the main attributes of the desired style) needs to be collected as training samples at any time, making it necessary to collect a large number of samples every time the style is changed, which not only increases costs, but also reduces the efficiency of model training.

### SUMMARY

In order to solve the above technical problem that the training of image style transfer model relies on a large number of training samples, which increases the training cost and reduces the training efficiency, the present disclosure provides an image style transfer method and apparatus, an image style transfer model training method and apparatus, a device, and a medium.

In a first aspect, the present disclosure provides an image style transfer model training method, and the method comprises:
acquiring a first number of portrait image samples, training a preset neural network model by using the portrait image samples to determine a portrait image generation model and portrait model parameters;
acquiring a second number of style image samples, training the portrait image generation model by using the style image samples to determine style model parameters, where the second number is less than the first number;
determining transfer model parameters based on the portrait model parameters and the style model parameters; and
generating a first image style transfer model based on the transfer model parameters and the preset neural network model.

In a second aspect, the present disclosure provides an image style transfer method, and the method comprises:
acquiring an image to be processed; and
inputting the image to be processed into a first image style transfer model or a second image style transfer model to generate a target stylized image of the image to be processed;
the first image style transfer model and the second image style transfer model are obtained based on the image style transfer model training method provided by any embodiment of the present disclosure.

In a third aspect, the present disclosure provides an image style transfer model training apparatus, and the apparatus comprises:
a portrait model parameter determination module, configured to acquire a first number of portrait image samples, train a preset neural network model by using the portrait image samples to determine a portrait image generation model and portrait model parameters;
a style model parameter determination module, configured to acquire a second number of style image samples, train the portrait image generation model by using the style image samples to determine style model parameters, where the second number is less than the first number;
a transfer model parameter determination module, configured to determine transfer model parameters based on the portrait model parameters and the style model parameters; and
a first image style transfer model generation module, configured to generate a first image style transfer model based on the transfer model parameters and the preset neural network model.

In a fourth aspect, the present disclosure provides an image style transfer apparatus, and the apparatus comprises:
an image-to-be-processed acquisition module, configured to acquire an image to be processed; and
a target stylized image generation module, configured to input the image to be processed into a first image style transfer model or a second image style transfer model to generate a target stylized image of the image to be processed;
the first image style transfer model and the second image style transfer model are obtained based on the image style transfer model training method described in any embodiment of the present disclosure.

In a fifth aspect, the present disclosure provides an electronic device, and the electronic device comprises:
a processor; and
a memory, configured to store an executable instruction;
the processor is used to read the executable instruction from the memory and execute the executable instruction to implement the steps of the image style transfer model training method described in any embodiment of the present disclosure, or to implement the steps of the image style transfer method described in any embodiment of the present disclosure.

In a sixth aspect, the present disclosure provides a computer-readable storage medium, the storage medium stores a computer program, and when the computer program is executed by a processor, the processor implements the steps of the image style transfer model training method described in any embodiment of the present disclosure, or implements the steps of the image style transfer method described in any embodiment of the present disclosure.

### BRIEF DESCRIPTION OF THE DRAWINGS

The above and other features, advantages, and aspects of embodiments of the present disclosure can become more apparent by referring to the following specific implementations and in conjunction with the accompanying drawings. Throughout the drawings, the same or similar reference numerals indicate the same or similar elements. It should be understood that the drawings are schematic, and the components and elements are not necessarily drawn to scale.

FIG. 1 is a flowchart of an image style transfer model training method according to an embodiment of the present disclosure;

FIG. 2 is a model architecture diagram of a preset neural network model according to an embodiment of the present disclosure;

FIG. 3 is a model architecture diagram of a combined neural network model according to an embodiment of the present disclosure;

FIG. 4 is a schematic diagram of a training process of a preset encoder model according to an embodiment of the present disclosure;

FIG. 5 is a flowchart of an image style transfer method according to an embodiment of the present disclosure;

FIG. 6 is a schematic structural diagram of an image style transfer model training apparatus according to an embodiment of the present disclosure;

FIG. 7 is a schematic structural diagram of an image style transfer apparatus according to an embodiment of the present disclosure; and

FIG. 8 is a schematic structural diagram of an electronic device according to an embodiment of the present disclosure.

### DETAILED DESCRIPTION

Embodiments of the present disclosure will be described in greater detail below with reference to the accompanying drawings. While some embodiments of the present disclosure are shown in the accompanying drawings, it should be understood, however, that the present disclosure may be implemented in various forms and should not be construed as being limited to the embodiments set forth herein; on the contrary, these embodiments are provided for a more thorough and complete understanding of the present disclosure. It should be understood that the accompanying drawings and embodiments of the present disclosure are for exemplary purposes only and are not intended to limit the scope of protection of the present disclosure.

It should be understood that all the steps recorded in the implementations of the method provided by the present disclosure can be performed in different order, and/or performed in parallel. Further, the implementations of the method can include additional steps and/or omit performing the steps illustrated. The scope of the present disclosure is not limited in this respect.

The term “comprise/include” and variations thereof as used herein mean openly comprising/including, i.e. “comprising/including but not limited to”. The term “based on” is “at least partially based on”. The term “one embodiment” means “at least one embodiment”; the term “another embodiment” means “at least one additional embodiment”; and the term “some embodiments” means “at least some embodiments”. Relevant definitions of other terms will be given in the following description.

It should be noted that the concepts of “first”, “second”, etc. mentioned in the present disclosure are only used for distinguishing different devices, modules, or units, and are not intended to limit the order or interdependence of the functions performed by these devices, modules, or units.

It should be noted that the modifications of “one” and “plurality” mentioned in the present disclosure are schematic rather than restrictive, and those skilled in the art should understand that unless otherwise expressly indicated in the context, it should be understood as “one or more”.

The names of messages or information interacted between a plurality of devices in the implementations of the present disclosure are used for illustrative purposes only and are not used to limit the scope of such messages or information.

Currently, one of the main ways to implement image style transfer is to train a neural network model. However, model training requires a large number of image samples, the collection of these image samples requires a lot of manpower, especially the collection of style images (e.g., cartoon images) comprising the desired image features needs more manpower. In this way, each time an image style is changed, a large number of style image samples need to be collected and the model training needs to be performed again, which seriously affects the efficiency of model training and the efficiency in implementing image style transfer.

In view of the above, embodiments of the present disclosure provide an image style transfer model training solution, in which, during the model training process, a preset neural network model is trained using a large number of portrait image samples, which are less difficult to collect, to generate a portrait image generation model, and then the portrait image generation model is secondarily trained by using a small number of style image samples, which are difficult to collect, to generate the style model parameters, and further, the portrait model parameters and the style model parameters are fused to generate a first image style transfer model, which not only reduces the difficulty of sample collection in the entire model training process, but also can implement the training of the image style transfer model with only a small number of style image samples, thereby greatly reducing the cost for model training, improving the efficiency of model training, and further improving the efficiency in implementing the transformation between different image styles.

The image style transfer model training solution provided in the embodiments of the present disclosure may be applied to any application scenario in which image style transfer or style fusion needs to be implemented, for example, can be applied to the generation of cartoon images, for another example, can be applied to the generation of game characters, for further example, can be applied to the stylized processing of user avatars, captured images, and the like in social networks, and the like.

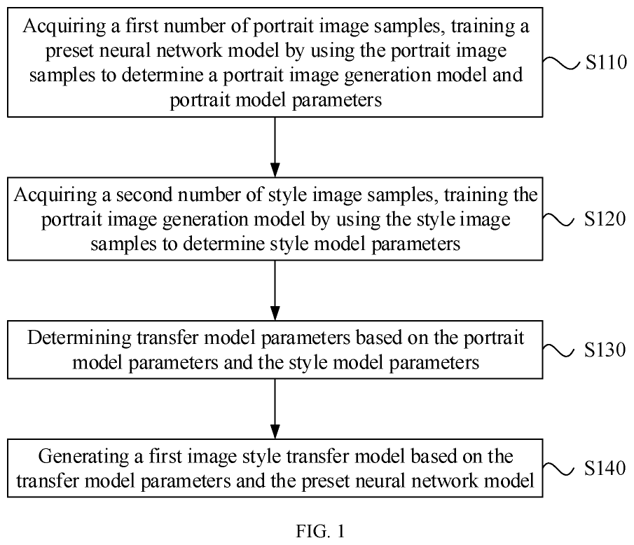

An image style transfer model training method provided in the embodiments of the present disclosure is first described below with reference to FIGS. 1 to 4.

In the embodiments of the present disclosure, the image style transfer model training method may be performed by an electronic device. The electronic device may include, but is not limited to, a notebook computer, a desktop computer, or a server, or other devices having capabilities of processing a mass of images.

FIG. 1 shows a schematic flowchart of an image style transfer model training method according to an embodiment of the present disclosure. As shown in FIG. 1, the image style transfer model training method may include the following steps.
S110: acquiring a first number of portrait image samples, training a preset neural network model by using the portrait image samples to determine a portrait image generation model and portrait model parameters.

Herein, the first number refers to the preset number of images. Considering that it is easy to collect portrait images, and in order to ensure the effect of the trained model, the first number may be set as a large value, such as tens of thousands. The portrait image samples are images including real human head or simulated human head, and are used as sample data for model training.

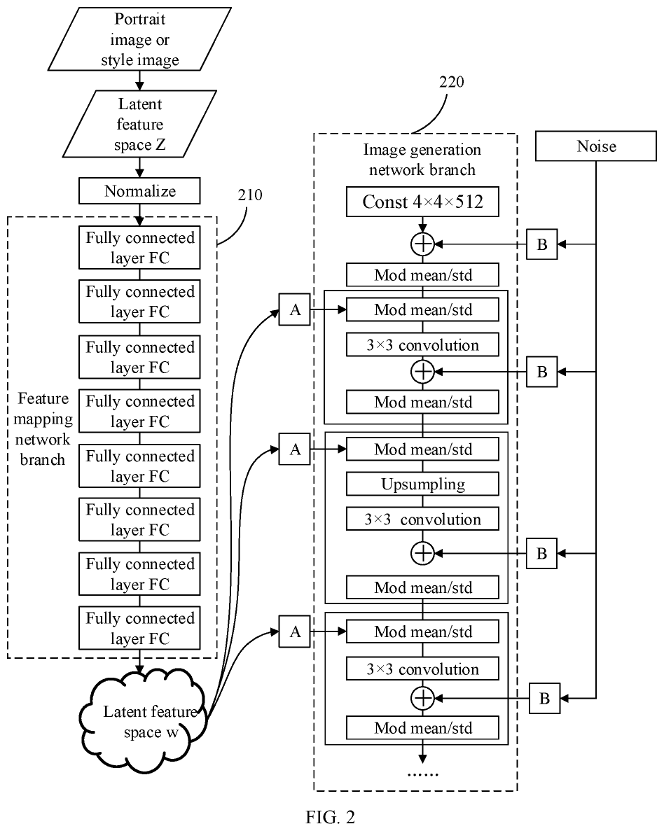

The preset neural network model is a neural network model set in advance, and the model parameters of the preset neural network model are default initial model parameters. The preset neural network model may, for example, be Generative Adversarial Networks (GANs). The embodiments of the present disclosure takes a case that the preset neural network model is a styleGAN (Style-Based Generator Architecture for Generative Adversarial Networks) model or a styleGAN2 model as an example. FIG. 2 shows a model architecture diagram of a preset neural network model exemplified by the styleGAN2 model. As shown in FIG. 2, the preset neural network model includes two network branches, namely a feature mapping network branch 210 and an image generation network branch 220. The feature mapping network branch 210 includes at least eight fully connected layers, which are used for mapping a latent feature z corresponding to an input portrait image into a latent feature space w. The image generation network branch 220 is used to input the feature A in the latent feature space w and noise feature B corresponding to random noise, and output a feature-fused portrait image.

The portrait image generation model is a model capable of generating a feature-fused portrait image, which can implement the function of inputting a portrait image and outputting a feature-fused portrait image. The portrait image generation model is obtained by performing model training on the preset neural network model, and the model parameters of the portrait image generation model are the portrait model parameters.

Specifically, the first number of portrait image samples are collected. Then, each model parameter of the preset neural network model is set as an initial model parameter (or a default value). These portrait image samples are then input into the preset neural network model one by one for training, a loss value is calculated based on a training output result and the corresponding input portrait image sample, and an error back-propagation is performed using the loss value to correct the model parameter until the model training reaches a training convergence condition. The corresponding model parameter when the training convergence condition is reached is determined as the portrait model parameter, and the preset neural network model at this time is used as the portrait image generation model.

Because the portrait image generation model and the portrait model parameters are obtained after training with tens of thousands of portrait image samples, which is sufficient to ensure that the accuracy of the model meets the requirements of practical applications, and therefore, the portrait image generation model and the portrait model parameters remain unchanged in the subsequent model training process and do no need to be retrained, and the portrait image generation model and the portrait model parameters can be used as a base model and base model parameters for at least one subsequent model training. Because the portrait image generation model and the portrait model parameters can be used as the basis for subsequent training of the style transfer models of different styles after only being trained once, the repetition training process of the image style transfer model training process can be reduced to a certain extent, thus improving the efficiency of model training.
S120: acquiring a second number of style image samples, training the portrait image generation model by using the style image samples to determine style model parameters.

Herein, the second number refers to the preset number of images. The second number is smaller than the first number. For example, the second number is a value that is at least two orders of magnitude smaller than the first number, specifically, the second number may be set as a relatively small value such as a few hundred. The style image samples are images comprising features of the main attributes of the desired style, and are used as sample data for the image style transfer model. The style model parameter is a model parameter obtained by model training using the style image samples. The style in the embodiments of the present disclosure refers to the painting style of an image and the overall color style, hue style, light style, etc. of the image. The painting style includes the character design such as the appearance, body type, hairstyle, and clothing as well as the sense of space and hierarchy in the layout of elements in the image. For example, the style may be a cartoon style, a crayon drawing style, an ink painting style, an oil painting style, a sketch style, and the like.

Specifically, after the desired style (e.g., a Japanese cartoon style, an American cartoon style, etc.) is determined, the second number of style image samples with this style are collected. Because in the embodiments of the present disclosure, the style image samples are used for secondary model training based on the portrait image generation model, and the portrait image generation model is able to accurately capture the main attribute features in the input image, therefore, only hundreds of style image samples are needed to involve in the model training in the model training process at this stage, so as to make the portrait image generation model accurately capture style features in the style image sample, thereby implementing the function of inputting an image of one style and outputting an image of another style. In this way, even if the image style is changed in response to business requirements, it is only necessary to collect several hundreds of style image samples corresponding to a new style and retrain the portrait image generation model, thus greatly reducing the cost for implementing the style transformation and improving model training efficiency for style transformation.

The secondary model training process described above is as follows: inputting each of the style image samples to the portrait image generation model for training, calculating the loss value according to a training output result and the corresponding input style image sample, performing the error back-propagation by using the loss value to correct the model parameter until the model training reaches a training convergence condition. The corresponding model parameter when the training convergence condition is reached is determined as the style model parameter, and the preset neural network model at this time is used as the style image generation model.

It can be understood that model structures of the preset neural network model, the portrait image generation model, and the style image generation model are exactly the same, and each of the preset neural network model, the portrait image generation model, and the style image generation model includes a feature mapping network branch and an image generation network branch; but the three models have different model parameters, corresponding to the initial model parameter, the portrait model parameter, and the style model parameter, respectively.
S130: determining transfer model parameters based on the portrait model parameters and the style model parameters.

The transfer model parameters refer to model parameters corresponding to a model (i.e., the first image style transfer model) capable of implementing the function of inputting a portrait image and outputting a style image, i.e., model parameters of a model that implements image style transfer.

Specifically, most of the related arts in implementing image style transfer utilizes portrait images and their corresponding style images for model training to obtain the transfer model parameters. However, such a training process requires a large number of paired portrait image samples and style image samples, which makes sample collection more difficult. Therefore, the model training strategy described above is not adopted in the embodiments of the present disclosure, instead, the portrait model parameters and the style model parameters are successively obtained by model training, and the two kinds of model parameters are applied to the same model structure to control the model to achieve different purposes of outputting the portrait images and the style images. Then, by fusing the two kinds of model parameters and applying the fused model parameters (i.e., the transfer model parameters) to the preset neural network model, the function of inputting a portrait image and outputting a style image can be implemented, and the style of the output style image is the same as that of the style image samples collected before.

As for the fusion mode of the portrait model parameter and the style model parameter, it may be to add, multiply, or divide, etc. according to preset weights, or it may be to provide a human-computer interaction interface to receive the information such as the fusion mode and the fusion parameters input by the user in real time to implement the fusion of model parameters. The specific fusion mode may be determined according to the business requirements such as the accuracy and effects of image style transfer.

In some embodiments, the fusion of the portrait model parameter and the style model parameter is performed by means of weighting. Then S130 includes: determining a third number of weighting coefficient sets; and for each network layer, weighting a portrait model parameter and a style model parameter of the network layer based on a weighting coefficient set corresponding to the network layer to determine a transfer model parameter of the network layer.

Herein, the third number is the preset number of weighting coefficient sets. A weighting coefficient set includes a weighting coefficient of the portrait model parameter and a weighting coefficient of the style model parameter in the same network layer. Then, the third number is less than or equal to the number of network layers included in the preset neural network model.

Specifically, the preset neural network model includes a plurality of network layers. Each network layer comprises at least one model parameter. A transfer model parameter corresponding to each model parameter is obtained by weighing the corresponding portrait model parameter and the corresponding style model parameter. On such basis, the third number is first determined according to the number of network layers included in the preset neural network model and the business requirements. For example, for an image having a size 512×512, its corresponding latent feature space w includes 16 feature layers, and the image generation network branch also includes 16 network layers. Then, the third number is a value less than or equal to 16. For example, if the business requirements focus on model accuracy, then the third number may be set to 16; if the business requirements focus on model training speed, then the third number may be set to a value less than 16, such as 8 or 4 and other smaller values. Then, the third number of weighting coefficient sets is determined. For example, if the third number is 16, then 16 sets of weighting coefficients are determined, and each set of weighting coefficients includes at least two weighting coefficients that are applied to the portrait model parameter and the style model parameter in a corresponding network layer, respectively. For another example, if the third number is 8, then 8 sets of weighting coefficients are determined, each set of weighting coefficients also includes at least two weighting coefficients that are applied to portrait model parameters and style model parameters in the corresponding two network layers, respectively. When the network layer comprises a plurality model parameters, the weighting coefficient set corresponding to the network layer may also include three or more weighting coefficients in order to configure the weighting coefficient for each model parameter in a more precise manner. Finally, the portrait model parameter and the style model parameter of each network layer are weighted by using each configured weighting coefficient set, such that the transfer model parameter of each model parameter comprised in each network layer can be obtained. In this way, the transfer model parameter can be obtained quickly and accurately while keeping the model parameters undistorted.
S140: generating a first image style transfer model based on the transfer model parameters and the preset neural network model.

Specifically, the first image style transfer model can be obtained by applying the obtained transfer model parameters to the preset neural network model.

The image style transfer model training method provided in each of the above embodiments of the present disclosure can train, during the model training process, the preset neural network model using a large number of portrait image samples that are less difficult to collect to generate a portrait image generation model that serves as a base model for subsequent style transfer model training, and then the portrait image generation model is secondarily trained by using a small number of style image samples, which are difficult to collect, to generate the style model parameters, which not only reduces the difficulty of sample collection in the entire model training process, but also can implement the training of the image style transfer model with only a small number of style image samples, thereby greatly reducing the cost for model training, improving the efficiency of model training, and further improving the efficiency in implementing the transformation between different image styles. In addition, because the model structure during the training process remains unchanged, and therefore, the parameter fusion can be directly performed on the portrait model parameters and the style model parameters to generate the first image style transfer model, without the need to fuse the model structures, thus reducing the complexity of model training and further improving the efficiency of model training.

Based on the technical solutions provided in the foregoing embodiments, the second number of style image samples may include a plurality of groups of the style image samples, one group of the style image samples corresponds to one image style. That is, the style image samples having a plurality of image styles may be collected simultaneously, and the collected second number of style image samples are grouped in accordance with the image styles.

On the basis of the above, S120 may be implemented as: training the portrait image generation model by using each group of the style image samples, respectively, and determining a style model parameter corresponding to each image style. Specifically, for a specific image style, each style image sample in the group of style image samples corresponding to the specific image style is input into the portrait image generation model one by one for training until a training convergence condition is reached, so that the style model parameter corresponding to the image style is obtained. According to this process, the style model parameter corresponding to each image style can be obtained.

On the basis of the above, S130 may be implemented as: determining the transfer model parameters based on the portrait model parameters and each style model parameter. Specifically, when there exist style model parameters corresponding to a plurality of image styles, the style model parameter corresponding to one image style can be selected to be fused with the portrait model parameters to obtain the transfer model parameters, to facilitate to subsequently implement the image style transfer for this image style. Alternatively, style model parameters corresponding to a plurality of image styles may be selected to be fused with and the portrait model parameters to obtain the transfer model parameters, to facilitate to subsequently implement the image style transfer for the mixed image styles. This may increase the style diversity and flexibility in the image style transfer.

Based on the technical solutions provided in the foregoing embodiments, after S110, the image style transfer model training method further includes a process of training a second image style transfer model, steps A to B are as follows. The second image style transfer model is also used to implement the function of inputting a portrait image and outputting a stylized image, but is capable of retaining more image detailed features, so that a degree of stylization is higher, the quality of the obtained stylized image is higher, and the detailed features are more accurate and delicate.
Step A: training a combined neural network model by using the portrait image samples to determine an encoder model parameter of a preset encoder model.

The combined neural network model is a model that is a combination of at least two neural network models.

In the embodiments of the present disclosure, the combined neural network model consists of the preset encoder model and an image generation network branch of the preset neural network model. The preset encoder model refers to an Encoder model, which is used to transform the input content (e.g., an image) into a dense vector with a fixed dimension. In the embodiments of the present disclosure, the preset encoder model is used to output a latent space feature vector based on an input portrait image sample. That is, the preset encoder model is used to replace the feature mapping network branch in the preset neural network model. Compared to the network structure in which the preset encoder model is added based on the preset neural network model for the purpose of increasing the detailed features of an image during the model training process, the network branch replacement mode in the embodiments of the present disclosure increases the image detailed features and simplifies the model structure. The image generation network branch is used to generate a portrait image result or a style image result based on the latent space feature vector output by the preset encoder model. The model parameter of the image generation network branch is maintained as a model parameter of the corresponding network branch in the portrait model parameters.

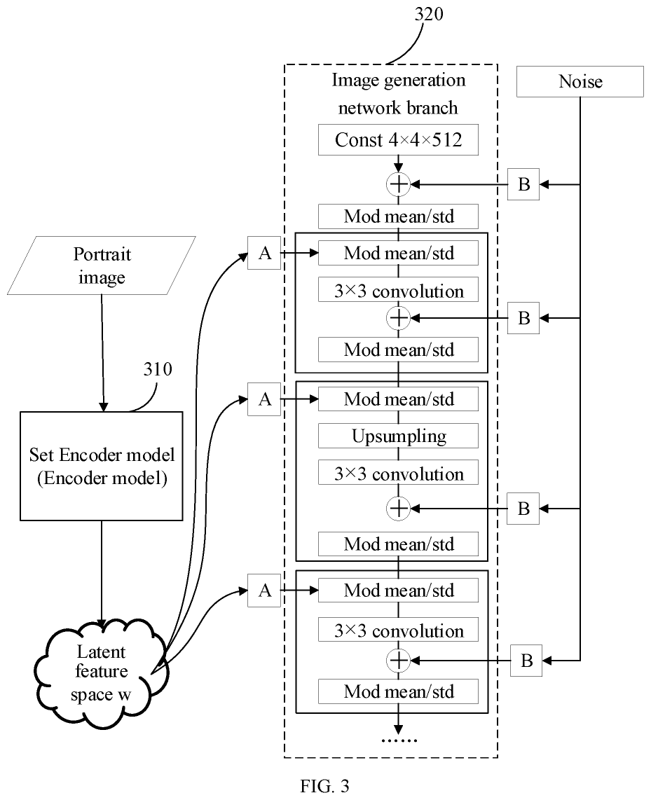

FIG. 3 shows a model architecture diagram of a combined neural network model according to an embodiment of the present disclosure. As shown in FIG. 3, the combined neural network model comprises a preset encoder model 310 and an image generation network branch 320. An input of the preset encoder model 310 is a portrait image or a style image, and an output of the preset encoder model 310 is a latent space feature vector w. The image generation network branch 320 is the same network branch in the preset neural network model, and the model parameter of this network branch in the preset neural network model still adopts the portrait model parameter of the corresponding network branch in the portrait image generation model, and the model parameter remains unchanged during the training process of the combined neural network model.

Specifically, considering that the feature mapping network branch in the preset neural network model such as styleGAN or styleGAN2 includes a plurality of identical fully connected layers, the coupling of a feature vector of each layer of the output latent space feature vector w is reduced, but the feature vector of each layer has the same spatial distribution, and accordingly some image features are lost to some extent. Therefore, in the embodiments of the present disclosure, the preset encoder model is used to replace the original feature mapping network branch in order to retain more image feature information in the original input image while ensuring that the coupling of the feature vector of each layer of the output latent space feature vector w is reduced.

According to the above description, the portrait image generation model is a base model for image style transfer model training, so that the first number of portrait image samples as described above is selected for training the combined neural network model to enable the trained combined neural network model to be used as a base model for subsequent model training as well. In a specific implementation, the model parameter of the preset encoder model in the combined neural network model is preset as an initial model parameter, and the model parameter of the image generation network branch in the combined neural network model is set as the portrait model parameter of a corresponding part. Then, the portrait image samples are input to the combined neural network model one by one for training, a loss value between the output image and the input image is calculated during the training process, and error back-propagation is performed using the loss value to correct the model parameter of the preset encoder model until a training convergence condition is reached. The model parameter of the preset encoder model when the training convergence condition is reached is determined as the encoder model parameter.
Step B: generating a second image style transfer model based on the preset encoder model, the encoder model parameter, an image generation network branch in the first image style transfer model, and a model parameter of the image generation network branch in the transfer model parameters.

Specifically, because the preset encoder model and the feature mapping network branch described above play a role in extracting image features without coupling relationship from the input image as input data of the image generation network branch, the focus of this network branch is to ensure the accuracy and diversity of the extracted image features, and therefore, this network branch may be selected as the preset encoder model with the encoder model parameter. It is the image generation network branch that really implements the image style transfer function, so that the focus of this network branch is to ensure that the model parameter of this network branch is the transfer model parameter obtained by fusing the portrait model parameter and the style model parameter. In summary, the second image style transfer model may be composed of the preset encoder model with the encoder model parameter and the image generation network branch with the transfer model parameter in the preset neural network model.

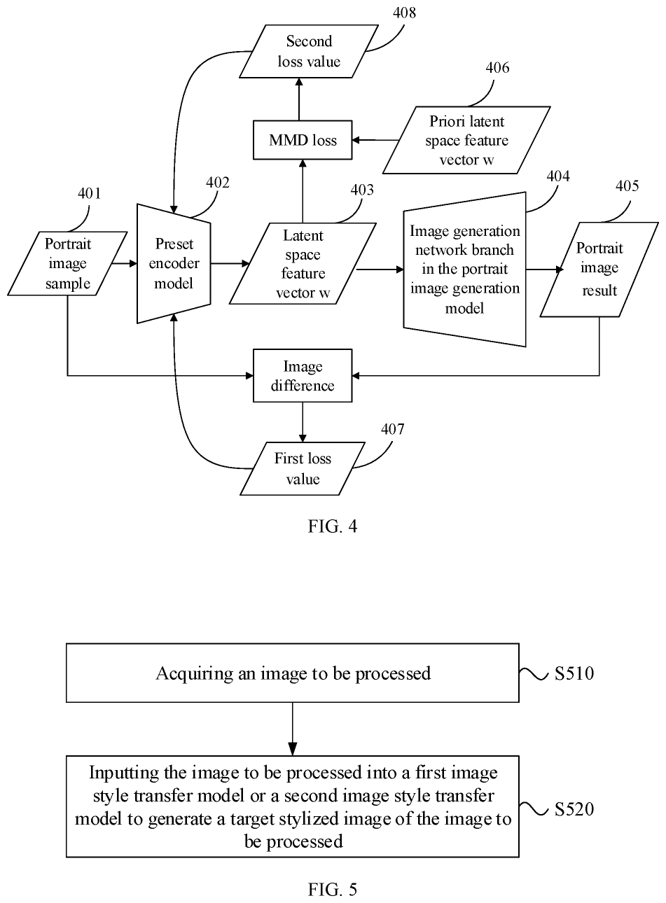

In some embodiments, according to the above description, in the combined neural network model, in order to increase the image detail features and to simplify the model structure, the feature mapping network branch in the preset neural network model is replaced by the preset encoder model. However, considering that the traditional Encoder model training method (i.e., the method of optimizing the model parameters by using the difference between the input image and the output image of the model) cannot well ensure the consistence between the distribution of the latent space feature vector w output by the encoder model and the distribution of the latent space feature vector w output by the portrait image generation model, which results in artifacts appearing in the style image output by the second image style transfer model. In the embodiments of the present disclosure, a maximum mean discrepancy (MMD) loss function is added during the training process of the Encoder model. The MMD is mainly used to measure a distance between two different but related distributions. Therefore, in the training process of the combined neural network model, the MMD loss function (MMD loss) may be added to calculate the difference between the latent space feature vector w with good feature distribution consistency output by the feature mapping network branch in the portrait image generation model and the latent space feature vector w with poor feature distribution consistency output by the preset encoder model, and error back-propagation is then performed iteratively using this difference during the model training process to further correct the model parameters, so as to continuously reduce the difference between the latent space feature vector w with poor feature distribution consistency output by the preset encoder model and the latent space feature vector w with good feature distribution consistency output by the feature mapping network branch in the portrait image generation model, thereby eliminating as far as possible the problem of inconsistency in the spatial distribution of the latent space feature vectors w described above, enabling the preset encoder model in the combined neural network model to output the latent space feature vector w with good feature distribution consistency, and further improving the image quality of the output style image. On such basis, the step A above can be implemented as the process shown in FIG. 4:
A1: inputting any one portrait image sample of the portrait image samples into the combined neural network model to determine a first feature vector and a portrait image result corresponding to the portrait image sample.

Specifically, any one portrait image sample 401 is input into a preset encoder model 402 in the combined neural network model, and is computed by the preset encoder model 402, and then the preset encoder model 402 outputs a first feature vector corresponding to the portrait image sample 401, i.e., a latent space feature vector w 403. Then, the latent space feature vector w 403 is input into an image generation network branch 404 in the portrait image generation model, and is computed by this network branch, and then the network branch outputs a portrait image result 405.
A2: inputting the portrait image sample into the portrait image generation model to determine a second feature vector corresponding to the portrait image sample.

Specifically, the portrait image sample in the above step A1 is input into the feature mapping network branch in the portrait image generation model, and is computed by this network branch, and then the network branch outputs the latent space feature vector w as a second feature vector corresponding to the portrait image sample 401, i.e., an a priori latent space feature vector w 406.
A3: determining a first loss value based on the portrait image sample and the portrait image result, and determining a second loss value by using a maximum mean discrepancy loss function based on the first feature vector and the second feature vector.

Specifically, an image difference operation is performed on the portrait image sample 401 and the portrait image result 405 to obtain a first loss value 407 for the training of the preset encoder model. Moreover, the MMD loss of the MMD loss function is calculated for the first feature vector and the second feature vector obtained above, that is, the MMD loss value between the priori latent space feature vector w 406 and the latent space feature vector w 403 is calculated as a second loss value 408.
A4: performing an error back-propagation on a model parameter of the preset encoder model based on the first loss value and the second loss value to iteratively correct the model parameter of the preset encoder model until model training reaches a training convergence condition.

Specifically, the first loss value 407 and the second loss value 408 are used for the error back-propagation to correct the model parameter of the preset encoder model 402. Through the cyclic process of step A1 to step A4 above, the model parameter of the preset encoder model can be iteratively corrected until a training convergence condition is reached (e.g., a difference between the model parameters satisfies a preset difference threshold or a preset number of iterations is reached), and at this time, the obtained model parameter is the encoder model parameter.

An image style transfer method provided in the embodiments of the present disclosure is described below with reference to FIG. 5.

In the embodiments of the present disclosure, the image style transfer method may be performed by an electronic device. The electronic device may include, but is not limited to, a mobile smart device such as a smart phone, a personal digital assistant (PDA), a tablet PC, a laptop, and a fixed terminal device such as a smart TV, a desktop computer, or a server.

FIG. 5 shows a schematic flowchart of an image style transfer method according to an embodiment of the present disclosure. As shown in FIG. 5, the image style transfer method may include the following steps.
S510: acquiring an image to be processed.

Specifically, an image that needs to be image-stylized is obtained as the image to be processed. For example, an image input by the user (e.g., a user avatar) may be received as the image to be processed.
S520: inputting the image to be processed into a first image style transfer model or a second image style transfer model to generate a target stylized image of the image to be processed.

The first image style transfer model is obtained by the image style transfer model training method illustrated in the foregoing embodiments, the model structure of the first image style transfer model is the model structure of the preset neural network model shown in FIG. 2, and the model parameter of the first image style transfer model is the transfer model parameter. The second image style transfer model is obtained by the image style transfer model training method illustrated in the foregoing embodiments, the model structure of the second image style transfer model is the model structure of the combined neural network model as shown in FIG. 3, and the model parameter of the second image style transfer model includes the encoder model parameter of the preset encoder model and the transfer model parameter of the image generation network branch.

Specifically, according to the above description, the first image style transfer model and the second image style transfer model are models that are capable of implementing the function of inputting a portrait image and outputting a style image and are obtained through training with a small number of style image samples of the desired image style. Therefore, the image to be processed can be input into the first image style transfer model or the second image style transfer model, and after model operation, a model output result, i.e., an image (the target stylized image) obtained after the image to be processed is stylized, can be obtained.

The image style transfer method provided in the foregoing embodiments of the present disclosure can use the trained first image style transfer model or the trained second image style transfer model to stylize the image to be processed to generate the target stylized image, thus improving the stylization fineness of the image to be processed, and thereby improving the image quality of the target stylized image.

In an implementation provided in the present disclosure, the stylization process of the image to be processed may be optimized, such as adding an optimization process for the latent space feature vector w in the computation process of the style transfer model, in order to further improve the stylization fineness of the image, thereby further improving the image quality of the target stylized image.

In some embodiments, when the style transfer model is the first image style transfer model, S520 may be implemented as below.
Step C: inputting the image to be processed into a feature mapping network branch in the first image style transfer model, and outputting a third feature vector of the image to be processed, i.e., a latent space feature vector w.
Step D: determining, based on the third feature vector and a reference feature vector, a first fusion feature vector corresponding to the image to be processed.

The reference feature vector is a feature vector corresponding to a reference style image output by the first image style transfer model. For example, a plurality of portrait images may be randomly determined and input into the first image style transfer model one by one, so that a style image corresponding to each of the portrait images is output. At least one style image (i.e., a reference style image) whose stylization effect (e.g., image quality, image detail features, and the like) meets certain requirements is selected from these output style images, and the reference feature vector is determined based on the latent space feature vector corresponding to the selected reference style image. If there is only one reference style image, then the latent space feature vector corresponding to the one reference style image is the reference feature vector. If there are a plurality of reference style images, then a latent space feature vector may be selected secondarily from the latent space feature vectors corresponding to the plurality of reference style images as the reference feature vector, or the latent space feature vectors corresponding to the plurality of reference style images may be weighted and fused to determine the reference feature vector.

Specifically, the third feature vector obtained in Step C and the reference feature vector are fused. For example, according to certain weighting coefficients, the weighted calculation is performed on the latent space feature vector w obtained in Step C and the latent space feature vector w determined by pre-selecting to obtain a result as a first fusion feature vector. The weighting coefficients herein may be fixed empirical values preset in advance, or may be input values that are input by the user and received in real time by the human-computer interaction interface provided. For the process of the weighting calculation, reference may be made to the description of the weighting calculation process of the model parameters above.
Step E: inputting the first fusion feature vector obtained in the step D into an image generation network branch in the first image style transfer model, and outputting the target stylized image of the image to be processed, i.e., a first stylized image.

In some other embodiments, when the style transfer model is a second image style transfer model, S520 may be implemented as:
Step C′: inputting the image to be processed into a preset encoder model in the second image style transfer model, and outputting a fourth feature vector of the image to be processed, i.e., a latent space feature vector w.
Step D′: determining, based on the fourth feature vector and a reference feature vector, a second fusion feature vector corresponding to the image to be processed.

The reference feature vector is a feature vector corresponding to a reference style image output by the second image style transfer model. The process of obtaining the reference feature vector can be seen in the description of the step C above, except that the first image style transfer model is replaced by the second image style transfer model.

Specifically, the third feature vector obtained in the step C′ and the reference feature vector are fused to obtain a result as a second fusion feature vector.
Step E′: inputting the second fusion feature vector obtained in the step D′ into an image generation network branch in the second image style transfer model, and outputting the target stylized image of the image to be processed, i.e., a second stylized image.

It is to be noted that because the reference feature vector is the latent space feature vector w corresponding to the reference style image with better stylization effect, which better retains the image features of the input image, the fusion of the reference feature vector with the latent space feature vector w (the third feature vector or the fourth feature vector mentioned above) corresponding to the image to be processed can further enrich the feature information of the latent space feature vector w. Therefore, the optimization process of the latent space feature vector w in the embodiments of the present disclosure can further improve the fineness of image stylization, thus further improving the image quality of the target stylized image.

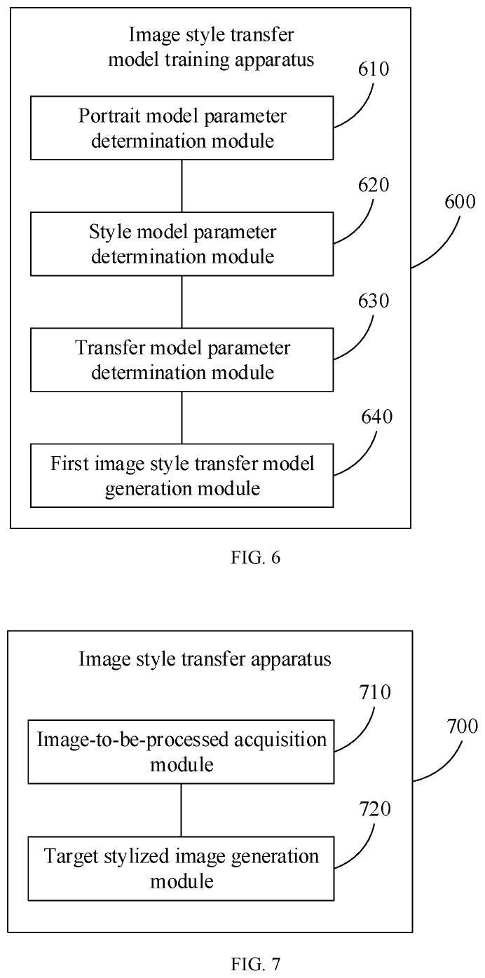

FIG. 6 shows a schematic structural diagram of an image style transfer model training apparatus according to an embodiment of the present disclosure.

As shown in FIG. 6, the image style transfer model training apparatus 600 may include:
a portrait model parameter determination module 610, configured to acquire a first number of portrait image samples, train a preset neural network model by using the portrait image samples to determine a portrait image generation model and portrait model parameters;
a style model parameter determination module 620, configured to acquire a second number of style image samples, train the portrait image generation model by using the style image samples to determine style model parameters, where the second number is less than the first number;
a transfer model parameter determination module 630, configured to determine transfer model parameters based on the portrait model parameters and the style model parameters; and
a first image style transfer model generation module 640, configured to generate a first image style transfer model based on the transfer model parameters and the preset neural network model.

The above image style transfer model training apparatus 600 provided in the embodiments of the present disclosure can train, during the model training process, the preset neural network model using a large number of portrait image samples that are less difficult to collect to generate a portrait image generation model that serves as a base model for subsequent style transfer model training, and then the portrait image generation model is secondarily trained by using a small number of style image samples, which are difficult to collect, to generate the style model parameters, which not only reduces the difficulty of sample collection in the entire model training process, but also can implement the training of the image style transfer model with only a small number of style image samples, thereby greatly reducing the cost for model training, improving the efficiency of model training, and further improving the efficiency in implementing the transformation between different image styles. In addition, because the model structure during the training process remains unchanged, and therefore, the parameter fusion can be directly performed on the portrait model parameters and the style model parameters to generate the first image style transfer model, without the need to fuse the model structures, thus reducing the complexity of model training and further improving the efficiency of model training.

In some embodiments, the image style transfer model training apparatus 600 further comprises a second image style transfer model generation module, configured to:
after training the preset neural network model by using the portrait image samples to determine the portrait image generation model and the portrait model parameters, train a combined neural network model by using the portrait image samples to determine an encoder model parameter of a preset encoder model; where the combined neural network model consists of the preset encoder model and an image generation network branch in the preset neural network model; the preset encoder model is used to output feature vectors based on the portrait image samples; the image generation network branch is used to generate a portrait image result or a style image result based on the feature vectors, and a model parameter of the image generation network branch is maintained as a model parameter of the image generation network branch in the portrait model parameters;
generate a second image style transfer model based on the preset encoder model, the encoder model parameter, an image generation network branch in the first image style transfer model, and a model parameter of the image generation network branch in the transfer model parameters.

Further, the second image style transfer model generation module is specifically used to:
input any one portrait image sample of the portrait image samples into the combined neural network model to determine a first feature vector and a portrait image result corresponding to the portrait image sample;
input the portrait image sample into the portrait image generation model to determine a second feature vector corresponding to the portrait image sample;
determine a first loss value based on the portrait image sample and the portrait image result, and determine a second loss value by using a maximum mean discrepancy loss function based on the first feature vector and the second feature vector; and
perform an error back-propagation on the model parameter of the preset encoder model based on the first loss value and the second loss value to iteratively correct the model parameter of the preset encoder model until model training reaches a training convergence condition.

In some embodiments, the second number of style image samples comprises a plurality of groups of the style image samples, one group of the style image samples corresponds to one image style.

Correspondingly, the style model parameter determination module 620 is specifically configured to:
train the portrait image generation model by using each group of the style image samples respectively, and determine a style model parameter corresponding to each image style.

Correspondingly, the transfer model parameter determination module 630 is specifically configured to:
determine the transfer model parameters based on the portrait model parameters and each style model parameter.

In some embodiments, the transfer model parameter determination module 630 is specifically configured to:
determine a third number of weighting coefficient sets; where the third number is less than or equal to a quantity of network layers comprised in the preset neural network model;
for each network layer of the network layers, weight a portrait model parameter and a style model parameter of the network layer based on a weighting coefficient set corresponding to the network layer to determine a transfer model parameter of the network layer.

It should be noted that the image style transfer model training apparatus 600 shown in FIG. 6 may perform various steps in the method embodiments shown in FIGS. 1 to 4, and implement various processes and effects in the method embodiments shown in FIGS. 1 to 4, which will not be repeated again herein.

FIG. 7 shows a schematic structural diagram of an image style transfer apparatus according to an embodiment of the present disclosure. As shown in FIG. 7, the image style transfer apparatus 700 may include:
an image-to-be-processed acquisition module 710, configured to acquire an image to be processed; and
a target stylized image generation module 720, configured to input the image to be processed into a first image style transfer model or a second image style transfer model to generate a target stylized image of the image to be processed.

Here, the first image style transfer model and the second image style transfer model are obtained based on the image style transfer model training method described in any of the foregoing embodiments.

The image style transfer apparatus 700 provided in the embodiments of the present disclosure can use the trained first image style transfer model or the trained second image style transfer model to stylize the image to be processed to generate the target stylized image, thus improving the stylization fineness of the image to be processed, and thereby improving the image quality of the target stylized image.

In some embodiments, the target stylized image generation module 720 is specifically configured to:
input the image to be processed into a feature mapping network branch in the first image style transfer model, and output a third feature vector of the image to be processed;
determine, based on the third feature vector and a reference feature vector, a first fusion feature vector corresponding to the image to be processed; where the reference feature vector is a feature vector corresponding to a reference style image output by the first image style transfer model; and
input the first fusion feature vector into an image generation network branch in the first image style transfer model, and output a first stylized image of the image to be processed.

In some other embodiments, the target stylized image generation module 720 is specifically configured to:
input the image to be processed into a preset encoder model in the second image style transfer model, and output a fourth feature vector of the image to be processed;
determine, based on the fourth feature vector and a reference feature vector, a second fusion feature vector corresponding to the image to be processed; where the reference feature vector is a feature vector corresponding to a reference style image output by the second image style transfer model; and
input the second fusion feature vector into an image generation network branch in the second image style transfer model, and output a second stylized image of the image to be processed.

It should be noted that the image style transfer apparatus 700 shown in FIG. 7 may perform various steps in the method embodiment shown in FIG. 5, and implement various processes and effects in the method embodiment shown in FIG. 5, which will not be repeated again herein.

An embodiment of the present disclosure further provides an electronic device. The electronic device may include a processor and a memory. The memory may be used to store an executable instruction. The processor may be used to read the executable instruction from the memory and execute the executable instruction to implement the steps of the image style transfer model training method in any of the foregoing embodiments, or to implement the steps of the image style transfer method in any of the foregoing embodiments.

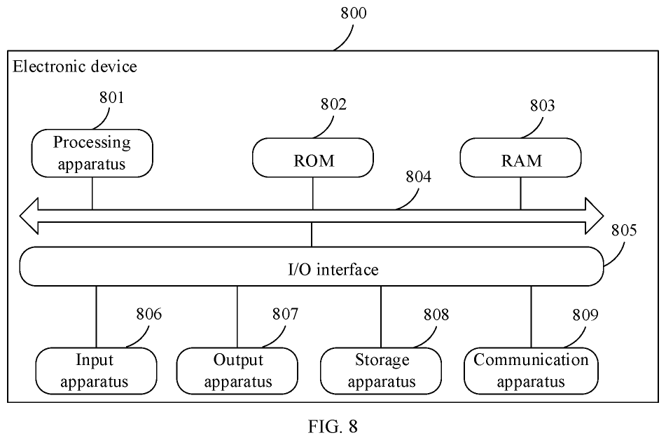

FIG. 8 shows a schematic structural diagram of an electronic device according to an embodiment of the present disclosure. In the following, referring specifically to FIG. 8, which shows a schematic structural diagram of an electronic device 800 applicable to implementing the embodiments of the present disclosure.

It is to be noted that the electronic device 800 illustrated in FIG. 8 is merely an example and shall not impose any limitations on the function and scope of application of the embodiments of the present disclosure.

As illustrated in FIG. 8, the electronic device 800 may include a processing apparatus 801 (e.g., a central processing unit, a graphics processing unit, etc.), which can perform various suitable actions and processing according to a program stored in a read-only memory (ROM) 802 or a program loaded from a storage apparatus 808 into a random-access memory (RAM) 803. The RAM 803 further stores various programs and data required for operations of the electronic device 800. The processing apparatus 801, the ROM 802, and the RAM 803 are interconnected by means of a bus 804. An input/output (I/O) interface 805 is also connected to the bus 804.

Usually, the following apparatus may be connected to the I/O interface 805: an input apparatus 806 including, for example, a touch screen, a touch pad, a keyboard, a mouse, a camera, a microphone, an accelerometer, a gyroscope, or the like; an output apparatus 807 including, for example, a liquid crystal display (LCD), a loudspeaker, a vibrator, or the like; a storage apparatus 808 including, for example, a magnetic tape, a hard disk, or the like; and a communication apparatus 809. The communication apparatus 809 may allow the electronic device 800 to be in wireless or wired communication with other devices to exchange data. While FIG. 8 illustrates the electronic device 800 having various apparatuses, it should be understood that not all of the illustrated apparatuses are necessarily implemented or included. More or fewer apparatuses may be implemented or included alternatively.

An embodiment of the present disclosure further provides a computer-readable storage medium, and the storage medium stores a computer program, when the computer program is executed by a processor, the processor is caused to implement the steps of the image style transfer model training method in any of the above embodiments, or to implement the steps of the image style transfer method in any of the above embodiments.

Compared with the prior art, the image style transfer method and apparatus, the image style transfer model training method and apparatus, the device, and the medium in the embodiments of the present disclosure have the following advantages:

1. In the model training process, the preset neural network model is trained using a large number of portrait image samples, which are less difficult to collect, to generate a portrait image generation model that serves as a base model for subsequent style transfer model training, and then the portrait image generation model is secondarily trained by using a small number of style image samples, which are difficult to collect, to generate the style model parameters, which not only reduces the difficulty of sample collection in the entire model training process, but also can implement the training of the image style transfer model with only a small number of style image samples, thereby greatly reducing the cost for model training, improving the efficiency of model training, and further improving the efficiency in implementing the transformation between different image styles.

2. In the model training process, the neural network model involved in training during acquisition of the portrait model parameters and the neural network model involved in training during acquisition of style model parameter are respectively a preset neural network model and a portrait image generation model obtained by training the preset neural network model, and both of them have the same model structure, so that subsequently, the parameter fusion can be directly performed on the portrait model parameters and the style model parameters to generate the first image style transfer model, without the need to fuse the model structures, thus reducing the complexity of model training and further improving the efficiency of model training.

Particularly, according to some embodiments of the present disclosure, the processes described above with reference to the flowcharts may be implemented as a computer software program. For example, some embodiments of the present disclosure include a computer program product, which includes a computer program carried on a non-transitory computer-readable medium. The computer program includes program codes for performing the methods shown in the flowcharts. In such embodiments, the computer program may be downloaded online through the communication apparatus 809 and installed, or may be installed from the storage apparatus 808, or may be installed from the ROM 802. When the computer program is executed by the processing apparatus 801, the above-mentioned functions defined in the image style transfer model training method or the image style transfer method of any embodiment of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electrical, magnetic, optical, electromagnetic, infrared, or semi-conductive system, apparatus, or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus, or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate, or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

In some implementations, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to perform the steps of the image style transfer model training method described in any of the above embodiments, or to perform the steps of the image style transfer method described in any of the above embodiments.

In the embodiments of the present disclosure, the computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, functionality, and operation of possible implementations of devices, methods, and computer program products according to various embodiments of the present disclosure. In this regard, each block in the flowcharts or block diagrams may represent a module, a program segment, or a portion of codes, the module, the program segment, or the portion of codes include one or more executable instructions for implementing specified logical functions. It should also be noted that, in some alternative implementations, the functions noted in the blocks may also occur in an order different from the order designated in the accompanying drawings. For example, two consecutive blocks can actually be executed substantially in parallel, and they may sometimes be executed in a reverse order, which depends on involved functions. It should also be noted that each block in the flowcharts and/or block diagrams and combinations of the blocks in the flowcharts and/or block diagrams may be implemented by a dedicated hardware-based system for executing specified functions or operations, or may be implemented by a combination of a dedicated hardware and computer instructions.

The involved units described in the embodiments of the present disclosure may be implemented by software, or may be implemented by hardware. The name of a unit does not constitute a limitation on the unit itself in some cases.

The functions described above in the present disclosure may be executed at least in part by one or more hardware logic components. For example, without limitations, exemplary types of the hardware logic components that can be used include: a field programmable gate array (FPGA), an application specific integrated circuit (ASIC), an application specific standard product (ASSP), a system on chip (SOC), a complex programmable logic device (CPLD), and the like.

In the context of the present disclosure, the machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electrical, magnetic, optical, electromagnetic, infrared, or semi-conductive system, apparatus, or device, or any suitable combination of the foregoing. More specific examples of the machine-readable storage medium include electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

The foregoing descriptions are merely the illustrations of the preferred embodiments of the present disclosure and the explanations of the technical principles involved. Those skilled in the art should understand that the scope of the disclosure involved in the present disclosure is not limited to the technical solutions formed by a specific combination of the technical features described above, and shall also cover other technical solutions formed by any combination of the technical features described above or equivalent features thereof without departing from the concept of the present disclosure. For example, the technical features described above may be mutually replaced with the technical features having similar functions disclosed in the present disclosure (but not limited thereto) to form new technical solutions.

In addition, while operations have been described in a particular order, it shall not be construed as requiring that such operations are performed in the stated particular order or in a sequential order. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be implemented in combination in a single embodiment. Conversely, various features described in the context of a single embodiment may also be implemented in a plurality of embodiments individually or in any appropriate sub-combination.

Although the present subject matter has been described in a language specific to structural features and/or method logical acts, it will be appreciated that the subject matter defined in the appended claims is not necessarily limited to the particular features or acts described above. Rather, the particular features and acts described above are merely exemplary forms for implementing the claims.

1. An image style transfer model training method, comprising:
acquiring a first number of portrait image samples, training a preset neural network model by using the portrait image samples to determine a portrait image generation model and portrait model parameters;
acquiring a second number of style image samples, training the portrait image generation model by using the style image samples to determine style model parameters, wherein the second number is less than the first number;
determining transfer model parameters based on the portrait model parameters and the style model parameters; and
generating a first image style transfer model based on the transfer model parameters and the preset neural network model.

2. The image style transfer model training method according to claim 1, further comprising:
training a combined neural network model by using the portrait image samples to determine an encoder model parameter of a preset encoder model; wherein the combined neural network model comprises the preset encoder model and an image generation network branch in the preset neural network model; the preset encoder model is used to output feature vectors based on the portrait image samples; the image generation network branch in the preset neural network model is used to generate a portrait image result or a style image result based on the feature vectors, and a model parameter of the image generation network branch in the preset neural network model is maintained as a model parameter, corresponding to the image generation network branch in the preset neural network model, in the portrait model parameters; and
generating a second image style transfer model based on the preset encoder model, the encoder model parameter, an image generation network branch in the first image style transfer model, and a model parameter, corresponding to the image generation network branch in the first image style transfer model, in the transfer model parameters.

3. The image style transfer model training method according to claim 2, wherein the training a combined neural network model by using the portrait image samples to determine an encoder model parameter of a preset encoder model comprises:
inputting any one portrait image sample of the portrait image samples into the combined neural network model to determine a first feature vector and a portrait image result corresponding to the portrait image sample;
inputting the portrait image sample into the portrait image generation model to determine a second feature vector corresponding to the portrait image sample;
determining a first loss value based on the portrait image sample and the portrait image result, and determining a second loss value by using a maximum mean discrepancy loss function based on the first feature vector and the second feature vector; and
performing an error back-propagation on a model parameter of the preset encoder model based on the first loss value and the second loss value to iteratively correct the model parameter of the preset encoder model until model training reaches a training convergence condition, wherein the model parameter of the preset encoder model, which is obtained when the model training reaches the training convergence condition, is the encoder model parameter.

4. The image style transfer model training method according to claim 2, wherein the model parameter of the preset encoder model in the combined neural network model is preset as an initial model parameter, and the model parameter of the image generation network branch in the combined neural network model is a portrait model parameter, corresponding to an image generation network branch in the portrait image generation model.

5. The image style transfer model training method according to claim 1, wherein the second number of style image samples comprises a plurality of groups of the style image samples, one group of the style image samples corresponds to one image style;
the training the portrait image generation model by using the style image samples to determine style model parameters comprises:
training the portrait image generation model by using the plurality of groups of the style image samples, respectively, and determining a style model parameters respectively corresponding to a plurality of image styles corresponding to the plurality of groups of the style image samples; and
the determining transfer model parameters based on the portrait model parameters and the style model parameters comprises:
determining the transfer model parameters based on the portrait model parameters and the style model parameters respectively corresponding to the plurality of image styles.

6. The image style transfer model training method according to claim 1, wherein the determining transfer model parameters based on the portrait model parameters and the style model parameters comprises:
determining a third number of weighting coefficient sets; wherein the third number is less than or equal to a quantity of network layers comprised in the preset neural network model;
for each network layer of the network layers, weighting a portrait model parameter and a style model parameter of the network layer based on a weighting coefficient set corresponding to the network layer to determine a transfer model parameter of the network layer.

7. An image style transfer method, comprising:
acquiring an image to be processed; and
inputting the image to be processed into a first image style transfer model to generate a target stylized image of the image to be processed;
wherein the first image style transfer model is obtained based on the image style transfer model training method according to claim 1.

8. The image style transfer method according to claim 7, wherein the inputting the image to be processed into a first image style transfer model to generate a target stylized image of the image to be processed comprises:
inputting the image to be processed into a feature mapping network branch in the first image style transfer model, and outputting a third feature vector of the image to be processed;
determining, based on the third feature vector and a reference feature vector, a first fusion feature vector corresponding to the image to be processed; wherein the reference feature vector is a feature vector corresponding to a reference style image output by the first image style transfer model; and
inputting the first fusion feature vector into an image generation network branch in the first image style transfer model, and outputting a first stylized image of the image to be processed, wherein the target stylized image comprises the first stylized image.

9-11. (canceled)

12. An electronic device, comprising:
a processor; and
a memory, configured to store an executable instruction;
wherein the processor is used to read the executable instruction from the memory and execute the executable instruction to implement an image style transfer model training method, or to implement an image style transfer method;
the image style transfer model training method comprises:
acquiring a first number of portrait image samples, training a preset neural network model by using the portrait image samples to determine a portrait image generation model and portrait model parameters;
acquiring a second number of style image samples, training the portrait image generation model by using the style image samples to determine style model parameters, wherein the second number is less than the first number;
determining transfer model parameters based on the portrait model parameters and the style model parameters; and
generating a first image style transfer model based on the transfer model parameters and the preset neural network model;
the image style transfer method comprises:
acquiring an image to be processed; and
inputting the image to be processed into the first image style transfer model to generate a target stylized image of the image to be processed.

13. A computer-readable storage medium, wherein the storage medium stores a computer program, and when the computer program is executed by a processor, the processor implements an image style transfer model training method, or implements an image style transfer method;
the image style transfer model training method comprises:
acquiring a first number of portrait image samples, training a preset neural network model by using the portrait image samples to determine a portrait image generation model and portrait model parameters;
acquiring a second number of style image samples, training the portrait image generation model by using the style image samples to determine style model parameters, wherein the second number is less than the first number;
determining transfer model parameters based on the portrait model parameters and the style model parameters; and
generating a first image style transfer model based on the transfer model parameters and the preset neural network model;
the image style transfer method comprises:
acquiring an image to be processed; and
inputting the image to be processed into the first image style transfer model to generate a target stylized image of the image to be processed.

14. (canceled)

15. The image style transfer model training method according to claim 3, wherein the model parameter of the preset encoder model in the combined neural network model is preset as an initial model parameter, and the model parameter of the image generation network branch in the combined neural network model is a portrait model parameter, corresponding to an image generation network branch in the portrait image generation model.

16. The image style transfer model training method according to claim 2, wherein the second number of style image samples comprises a plurality of groups of the style image samples, one group of the style image samples corresponds to one image style;
the training the portrait image generation model by using the style image samples to determine style model parameters comprises:
training the portrait image generation model by using the plurality of groups of the style image samples, respectively, and determining style model parameters respectively corresponding to a plurality of image styles corresponding to the plurality of groups of the style image samples; and
the determining transfer model parameters based on the portrait model parameters and the style model parameters comprises:
determining the transfer model parameters based on the portrait model parameters and the style model parameters respectively corresponding to the plurality of image styles.

17. The image style transfer model training method according to claim 3, wherein the second number of style image samples comprises a plurality of groups of the style image samples, one group of the style image samples corresponds to one image style;
the training the portrait image generation model by using the style image samples to determine style model parameters comprises:
training the portrait image generation model by using the plurality of groups of the style image samples, respectively, and determining style model parameters respectively corresponding to a plurality of image styles corresponding to the plurality of groups of the style image samples; and
the determining transfer model parameters based on the portrait model parameters and the style model parameters comprises:
determining the transfer model parameters based on the portrait model parameters and the style model parameters respectively corresponding to the plurality of image styles.

18. The image style transfer model training method according to claim 2, wherein the determining transfer model parameters based on the portrait model parameters and the style model parameters comprises:
determining a third number of weighting coefficient sets; wherein the third number is less than or equal to a quantity of network layers comprised in the preset neural network model;
for each network layer of the network layers, weighting a portrait model parameter and a style model parameter of the network layer based on a weighting coefficient set corresponding to the network layer to determine a transfer model parameter of the network layer.

19. The image style transfer model training method according to claim 3, wherein the determining transfer model parameters based on the portrait model parameters and the style model parameters comprises:
determining a third number of weighting coefficient sets; wherein the third number is less than or equal to a quantity of network layers comprised in the preset neural network model;
for each network layer of the network layers, weighting a portrait model parameter and a style model parameter of the network layer based on a weighting coefficient set corresponding to the network layer to determine a transfer model parameter of the network layer.

20. The image style transfer model training method according to claim 4, wherein the determining transfer model parameters based on the portrait model parameters and the style model parameters comprises:
determining a third number of weighting coefficient sets; wherein the third number is less than or equal to a quantity of network layers comprised in the preset neural network model;
for each network layer of the network layers, weighting a portrait model parameter and a style model parameter of the network layer based on a weighting coefficient set corresponding to the network layer to determine a transfer model parameter of the network layer.

21. An image style transfer method, comprising:
acquiring an image to be processed; and
inputting the image to be processed into a second image style transfer model to generate a target stylized image of the image to be processed;
wherein the second image style transfer model is obtained based on the image style transfer model training method according to claim 2.

22. The image style transfer method according to claim 21, wherein the inputting the image to be processed into a second image style transfer model to generate a target stylized image of the image to be processed comprises:
inputting the image to be processed into a preset encoder model in the second image style transfer model, and outputting a fourth feature vector of the image to be processed;
determining, based on the fourth feature vector and a reference feature vector, a second fusion feature vector corresponding to the image to be processed; wherein the reference feature vector is a feature vector corresponding to a reference style image output by the second image style transfer model; and
inputting the second fusion feature vector into an image generation network branch in the second image style transfer model, and outputting a second stylized image of the image to be processed, wherein the target stylized image comprises the second stylized image.

23. An electronic device, comprising:
a processor; and
a memory, configured to store an executable instruction;
wherein the processor is used to read the executable instruction from the memory and execute the executable instruction to implement the image style transfer method according to claim 21.

24. A computer-readable storage medium, wherein the storage medium stores a computer program, and when the computer program is executed by a processor, the processor implements the image style transfer method according to claim 21.
